(19) United States
(12) Patent Application Publication
(10) Pub. No.: US 2022/0324101 A1
(43) Pub. Date: Oct. 13, 2022

(54) CUMULATIVE LEARNING ROBOT EXECUTION PLAN GENERATION

(71) Applicant: Intel Corporation, Santa Clara, CA (US)

(72) Inventors: Rita H. Wouhaybi, Portland, OR (US); Hassnaa Moustafa, San Jose, CA (US)

(21) Appl. No.: 17/850,536

(22) Filed: Jun. 27, 2022

(51) Int. Cl. B25J 9/16

(52) U.S. Cl. CPC B25J 9/163; B25J 9/161; B25J 9/1671; B25J 9/1682

(57) ABSTRACT

System and techniques for cumulative learning robot execution plan generation are described herein. A first execution plan report based on execution of a first execution plan by a first robot may be received. Here, the first execution plan report includes a first metric for a first operation of the first execution plan. A second execution plan report based on execution of a second execution plan by a second robot may also be received that includes a second metric for a second operation of the second execution plan. Here, the second operation corresponds to the first operation. The first metric and the second metric are analyzed to determine that the second operation is an improvement to the first operation. Then, a modified first execution plan that replaces the first operation with the second operation may be transmitted to the first robot.

### TECHNICAL FIELD

Embodiments described herein generally relate to execution plans and more specifically to the cumulative learning robot execution plan generation.

### BACKGROUND

Robots and other autonomous agents may be programmed to complete complex real-world tasks. Robots may use artificial intelligence (AI) to perform tasks in industrial environments. Robots span a wide range of industrial applications, such as smart manufacturing assembly lines, multi-robot automotive component assembly, computer and consumer electronics fabrication, smart retail and warehouse logistics, robotic datacenters, etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for cumulative learning robot execution plan generation, according to an embodiment.

FIG. 2 is a block diagram of an example of an environment including a system for cumulative learning robot execution plan generation, according to an embodiment.

FIG. 3 is a block diagram of an example of an environment including a system for cumulative learning robot execution plan generation, according to an embodiment.

FIG. 4 illustrates a flow diagram of an example of a method for cumulative learning robot execution plan generation, according to an embodiment

FIG. 5 is a block diagram illustrating an example of a machine upon which one or more embodiments may be implemented.

### DETAILED DESCRIPTION

One particular type of robot is called an autonomous mobile robot (AMR). AMRs are typically used in industrial settings to perform various tasks, which may be simple or complex, solo or collaborative. AMRs are of diverse capabilities and are manufactured by different vendors, which makes it difficult to unify software stacks across AMRs and to have task assignment solutions interoperable with any AMR. In some examples, an AMR may include a vehicle. In some examples, an AMR may include equipment such as wheels, a drive train, a motor, etc. In some examples, the techniques discussed for an AMR may apply to autonomous vehicles generally, for example in certain environments.

The AMRs may have limited computing capabilities because AMRs may be old or designed to limit energy consumption. As a result of the limited computing capabilities, AMRs may not be able to process or compare different execution plans, or different options for execution plans, to determine the most efficient execution plan for an experienced scenario.

For example, facing a situation, a robot may be faced with three different choices and the robot often doesn't have enough resources or time to further analyze the outcome of the three options. Doing so would need lots of computing and would require more time than is available to react. Thus, the system may include a cloud server or controller that may use AI to generate a confidence score for each of the three choices, which could be done using classification or clustering methods. Moreover, cloud robotics, as described above, may be well suited to allow for transfer learning. For example, retrospectively analyzing whether a particular robot operating at the edge could have chosen an even better reaction to a situation. This knowledge may then be transferred to that robot and other robots with similar contexts. However, this transfer is not live, and the robot may have waste (e.g., time or excess material used) because of the lag time analyzing the robot's previous runs. The present disclosure presents a method of cumulative learning robot execution plan generation that enables a robot's execution plan to be run, simulated, analyzed, and updated on-demand across one or more robots.

Systems and techniques described herein may provide cumulative generation of robot execution plans. The cloud server, or controller, may be connected to multiple edge node devices that are each connected to a robot. The cloud server may receive a situation or scenario from one of the edge node devices and may send alternate execution plans to each of the robots to run each of the execution plans in parallel. As each of the robots completes their execution plans, their respective edge node devices may send an execution plan report to the controller so the controller may compare metrics from each of the execution plan reports. The controller may then invoke clustering algorithms or any other machine learning/analytics technique to compare the metrics of each of the runs in parallel and determine an optimum result. The execution plan that achieved the optimum result may then be sent to each of the edge node devices to be shared with each of the robots in the scenario.

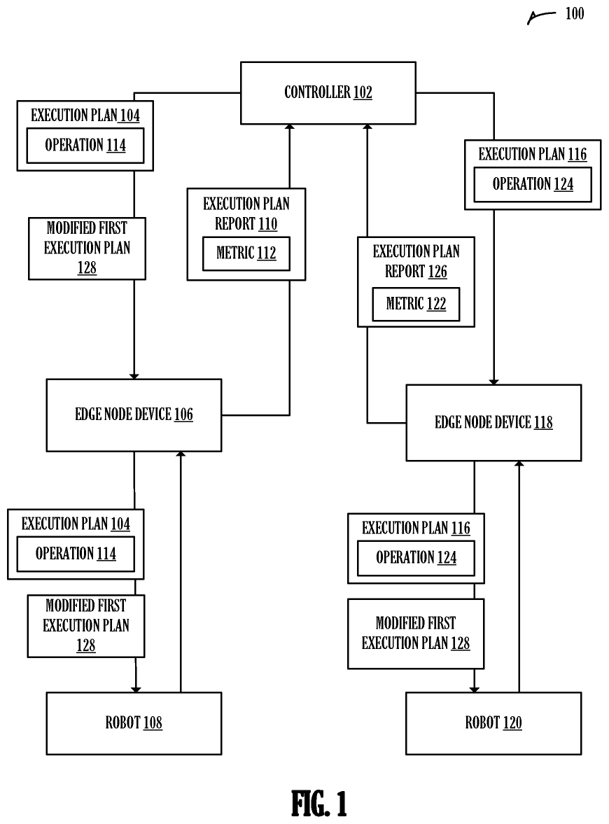

Systems and techniques described herein may provide cumulative generation of robot execution plans. Multiple robots may be a simulation run within the controller (Simulation in loop “SIL”). In such an example, the execution plan report may include a grouping of parameters that describe the scenario experienced by the robots. The controller may then generate simulation environments based on the grouping of parameters to define the bounds of operation of the robots in simulation. The controller may then send multiple test execution plans to each of the simulation environments to simultaneously run the different execution plans in simulations. After the simulations, the controller may analyze the metrics of the simulations to determine an improved execution plan. The improved execution plan may then be sent to the edge node device to be uploaded to the robot. This cumulative generation of the robot execution plans decreases the time it takes to find an optimal execution plan and optimizes the robotic operations in real-time. The method of cumulative generation of an execution plan will be discussed below with reference to FIGS. 1-5.

FIG. 1 is a block diagram of an example of an environment including a system 100 for cumulative learning robot execution plan generation, according to an embodiment. The system 100 may operate a method for cumulative learning robot execution plan generation. The system 100 may include a controller 102, a first edge node device 106, a first robot 108, a second edge node device 118, and a second robot 120.

The controller 102 may be connected to the first edge node device 106 and the second edge node device 118 to transmit execution plans and communicate about the operations of the first robot 108 and the second robot 120, respectively. In an example, the controller 102 may be a cloud server.

An execution plan is a sequence of processes or instructions that provide robots with instructions on how to accomplish a task. The execution plan may set bounds or parameters for any functional component of the robot. Moreover, the execution plan may send updates to the robot while the robot is completing a task to improve the robot's performance. The execution plans may include multiple operations that together form the execution plan. Adjustments to the operations within the execution plan may alter the results of the robot running the execution plan. The cumulative learning robot execution plan generation may be leveraged to decrease downtime and increase the quality of operations for a robot, or a group of robots.

The robots (e.g., the first robot 108 and the second robot 120) may be any type of robot, or machine. For example, the first robot 108 and the second robot 120 may be autonomous mobile robots (AMRs). In examples, the first robot 108 and the second robot 120 may be AMRs operating in similar environments, such that the system 100 may use the execution plan reports to cumulatively generate an execution plan of a robot. In as such, the robots may operate simultaneously or in parallel to one another. Because the robots may operate simultaneously or in parallel there is less delay in forming an updated execution plan, and the controller 102 may cumulatively generate an execution plan for a robot. Once the execution plan is generated, the controller 102 may transmit the execution plan to the edge node device to update the execution plan of the robot while the robot is in operation.

In an example, operations of an execution plan may include parameters that control a robot. For example, the robot may be a welder, and operations of the execution plan may, in isolation or combination, control wire feed rate, gas flow rate, robot arm speed, robot move direction, angle or orientation of welding wand, a welding sequence, or any other operation that may control a robotic welder. In another example, the robot may be a painter, and operations of the execution plan may, in isolation or combination, control pump rate, an angle of application, a robot span direction, a robot span speed, a sequence of application, or any other operation that may control a robotic painter. In examples, the robot may be a drone, and operations of the execution plan may, in isolation or combination, control propulsion factors (e.g., motor speed, motor direction, or any parameter that may affect the drone's pitch, yaw, or roll) or navigational factors (e.g., controls for vision systems, AI to avoid collisions, or any other navigation system on a drone), or any other operations of the drone. In yet another example, operations may in isolation or combination, be any control, sequence, or process to instruct the robot on how to complete a task.

In some examples, an edge node device (e.g., the first edge node device 106 or the second edge node device 118) may enable communication between the controller 102 and a robot (e.g., the first robot 108 or the second robot 120) and provide computing capabilities for the robots. In examples, the controller 102 may supplement the computing powers of the edge node devices to help with more advanced calculations, or to help reduce a computational load on the edge node devices. Decreasing the computational load on the edge node devices may decrease the system requirements for the edge node devices and reduce energy consumption by the edge node devices. Moreover, the controller 102 may help the edge node devices compute calculations that require more computing capabilities than those possessed by the edge node devices.

In an example, the method may include receiving, by processing circuitry of the controller 102, a first execution plan report 110 based on execution of a first execution plan 104 by the first robot 108. The first execution plan report 110 may include a first metric 112 for a first operation 114 of the first execution plan 104. In another example, the controller 102 may also receive a second execution plan report 126 based on the execution of a second execution plan 116 by the second robot 120, the second execution plan report 126 including a second metric 122 for a second operation 124 of the second execution plan 116. In examples, the second operation 124 may correspond to the first operation 114. For example, the first operation 114 may instruct a robot to apply a weld to a car body, and the second operation 124 may instruct a different robot to apply the same weld to a different car body. In examples, the robots that receive the first operation 114 and the second operation 124 may be in the same factory, or in another example, the robots that run first operation 114 and the second operation 124 may be in different parts of the world manufacturing same or similar products.

The metrics (e.g., the first metric 112 or the second metric 122) of the execution plan reports (e.g., the first execution plan report 110 or the second execution plan report 126) may be any measurement or result of a robot running an execution plan. For example, the metrics may be a total run time, an amount of idle time during the run, a distance traveled by the robot during the run, a count of faults, deviations, or errors encountered during the run, or any other recordable information from a robot running the execution plan. In another example, the metrics may be a characteristic of a job completed, for example, the metric may be a thickness, average, standard deviation, or any other attribute of the applied weld, paint, coating, or other applicable matter by the robot during the run. In examples, the metrics may be captured by the resources used by the robot during the run. In another example, the metrics may be captured by one or more sensors in communication with the robot.

The controller 102 may compare the first metric 112 to the second metric 122 to determine that the second operation 124 is an improvement to the first operation 114. In comparing the operations of two robots an improvement is not always more or less. For example, if comparing the run times of two robots completing the same or similar tasks, a lower run time is an improvement over a longer run time. In another example, if comparing the rest time or stoppage time of two robots completing the same or similar tasks, a lower value would be an improvement over a higher value. In yet another example, if comparing weld, coating, or paint thickness for quality indicators of two robots completing the same or similar tasks, a greater applied thickness may be an improvement over a lower applied thickness. In contrast, if material waste is of concern, less material used may be an improvement to a higher quantity of material used. Thus, the term improvement may vary based on the tasks the robot is completing and the metrics reported from the execution plan reports to the controller. The above-mentioned examples are purely illustrative and are not intended to limit the scope of the present disclosure.

In an example, the controller 102 may complete analysis (e.g., comparisons) of metrics in various ways. For example, the controller 102 may invoke a cluster of nodes to compare the test plan and the second execution plan 116 to determine whether the test plan is an improvement over the second execution plan 116. The controller 102 may in the same way invoke a cluster of nodes to analyze any test plan against any original execution plan or any other test plan. In this way, the controller 102 may continue to adjust execution plans and compare the resulting metrics of the adjusted execution against previous or original execution plans. In yet another example, the controller 102 may complete comparisons in any other AI method for comparisons of two or more metrics.

In an example, the controller 102 may transmit a modified first execution plan 128 to the first edge node device 106 to run on the first robot 108. In an example, the modified first execution plan 128 may replace the first operation 114 with the second operation 124 because the simulation proves that the second operation 124 is an improvement over the first operation 114. In an example, the controller 102 may transmit the second operation 124 to the first edge node device 106 and the second edge node device 118 to update the execution plans for the first robot 108 and the second robot 120, respectively.

In examples, one of the execution plans (e.g., the first execution plan 104 or the second execution plan 116) may be a test plan. In the test plan, an operation (e.g., the first operation 114 or the second operation 124) may be changed to compare against an original execution plan to see if the changes made to the operation are an improvement over the original test plan. For example, the first execution plan 104 may be a test plan. The test plan of the first execution plan 104 may change the first operation 114 from an original of the first execution plan 104. Thus, the comparison of the first metric and the second metric may be indicative of whether the test plan is an improvement over the original first execution plan 104 or the second execution plan 116.

In examples, one of the robots (e.g., either the first robot 108 or the second robot 120) may be simulated. For example, the execution plan report (e.g., the first execution plan report 110 or the second execution plan report 126) may include a grouping of parameters. The grouping of parameters may define the boundaries of the operation of the robots. In examples, the controller 102 may use the grouping of parameters of operation to generate a simulation. The controller 102 may generate multiple simulations, for example, one or more simulations based on the grouping of parameters. In an example. the controller 102 may run each of the one or more simulations simultaneously or in parallel. The controller 102 may use the simulations to quickly test changes to the execution plans (e.g., the first execution plan 104 or the second execution plan 116).

The controller 102 may execute the generated simulations to determine a best execution plan. For example, the controller 102 may then generate a first test execution plan and a second test execution plan. The first and second test execution plans each may include one or more operations performed by a robot in the simulation. In examples, the first and second test execution plans may have variations of the same operations. In another example, the first and second test execution plans may have variations of different operations of the execution plans. The controller 102 may then compare (e.g., by invoking a cluster of nodes or any other comparison technique used in learning algorithms) results from the first and second test execution plans running in simulation to determine whether the first test execution is an improvement to the second test execution plan. In one example, the controller 102 may then compare the better of the first and second test execution plan to a third, fourth, or nth test execution plan to determine the best test execution plan.

In another example, the controller 102 may generate, execute, and compare any number of test execution plans to cumulatively get results and determine the best execution plan for the provided grouping of parameters. In yet another example, the controller 102 may compare any number of test execution plans running in parallel in any number of simulations to compare the results of all the different execution plans running in each of the simulations to find a best execution plan for the robots. Once a best execution plan is determined, the controller 102 may transmit the best execution plan to the robot (e.g., the first robot 108 or the second robot 120) via the edge node devices (e.g., the first edge node device 106 and the second edge node device 118), respectively.

In an example, the robots (e.g., the first robot 108 or the second robot 120) running the execution plan (e.g., the first execution plan 104 or the second execution plan 116) may have a deviation, or a fault or variation from a predicted performance of the robot during execution of the execution plan. When the execution plans have a deviation, the edge node devices (e.g., the first edge node device 106 and the second edge node device 118) may communicate the deviation to the controller in the execution plan reports (e.g., the first execution plan report 110 and the second execution plan report 126).

In an example, the controller (e.g., the controller 102) may generate simulations based on the deviation experienced by the robot and multiple test execution plans. Each of the test execution plans may include changes to the operations of the execution plan (e.g., the first execution plan 104 or the second execution plan 116). The controller may run all the simulations with all the test execution plans in parallel. In another example, the controller may run all the simulations with all the test execution plans simultaneously. The controller may then compare the metrics from each simulation to determine whether each test execution plan is an improvement over the first execution plan 104 or the second execution plan 116. The controller may generate an updated test by finding the best operational changes and combining those changes into an updated test plan. The controller may transmit the updated test plan to the edge node device to live-update the robot that experienced the deviation.

In an example, a first robot (e.g., the first robot 108 context (e.g., factory environment, smart city). The first robot 108 may be faced with a situation (e.g., a scenario in that the first robot needs to make a decision). There may be an execution plan (e.g., an AI algorithm) running on the edge node device, which may take, for example, two msec to run. The first robot 108 may need to react in less than five msec. Thus, if the first robot is presented with three options (or execution plans), the edge node device and the first robot only have time to pick a response without any analysis of how these choices will impact the first robot or a second robot (e.g., the second robot 120) or the environment. So, the edge node device may choose one of the three options it is presented with and run that on the first robot 108.

While that first option is running on the first robot 108, the edge node device may send all the data to a cloud server (e.g., the controller 102). The cloud server may then request an algorithm (or execution plan) that is being run on the second edge node device and test the algorithm that is being run on the second edge node device in the simulated environment. The cloud server may then present the algorithm that is being run on the second edge node robot with the two options that weren't chosen by the first robot 108 and run the two execution plans on the second robot 120. In examples, the second robot may run these two execution plans on the robot in the situation. In another example, the second robot 120 may run these execution plans in a simulation and send the results back to the controller for analysis.

In yet another example, if there is a robot that is running the same execution plan as the first robot 108 or the second robot 120, the cloud server could then use techniques of federated learning to update across these robots. There may even be a list of options presented to each robot as an outcome of the learning (e.g., execution plan choice conditioned by context).

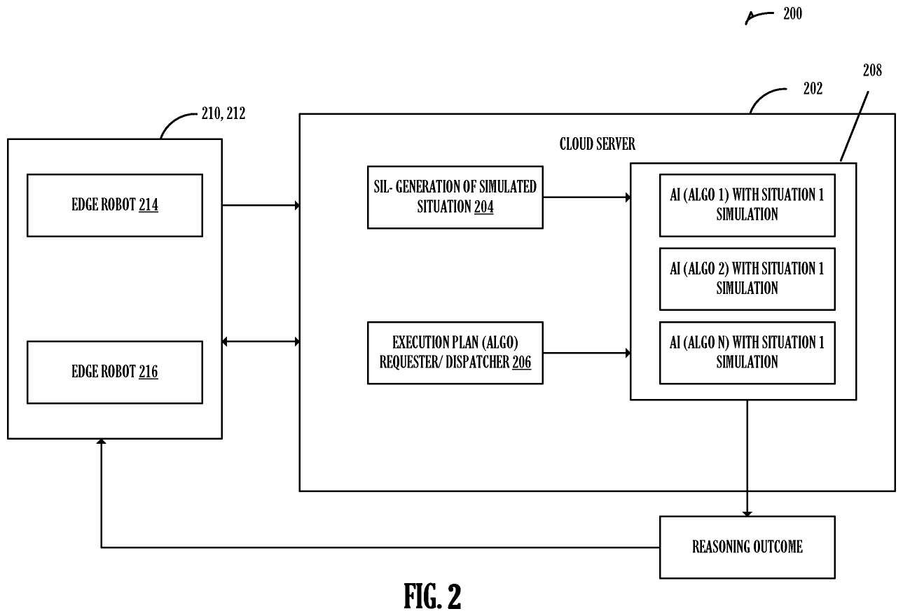

FIG. 2 is a block diagram of an example of an environment including a system 200 for cumulative learning robot execution plan generation, according to an embodiment. In FIG. 2, the Simulation-In-the Loop (SIL) process may include a cloud server 202. The SIL process will be discussed below.

In an example, the cloud server 202 applies SIL through the generation of simulated environments for true situations. The edge robots (e.g., an edge robot 214 and an edge robot 216) may share situational data with the cloud server 202. The edge node devices (e.g., an edge node device 210 and an edge node device 212) may be connected to the robots and may foster communication between the robots and the cloud server. A simulation generator 204 of the cloud server may generate simulations that may be run within a simulation environment 208. The data transferred between the edge node devices and the cloud server may be used by the simulation generator 204 to shape the simulation environment 208 for each true situation. The cloud server 202 may request the execution plans (e.g., AI algorithms) from the edge node device, or the edge node robots on-demand to execute in the simulation environment 208 for each situation using the compute resources of the cloud server 202. In an example, the cloud server may include an execution plan requester and dispatcher 206. The execution plan requester and dispatcher 206 may request the execution plans from the edge node devices and send the execution plans to the simulation environment 208. Several execution plans may be executed simultaneously, or in parallel, for each simulated situation. Each execution plan may also execute for a combination of situations.

In an example, the outcome of the SIL execution plan runs may preview the different outcomes for each AI execution plan for a particular situation and will reason the right decision to be taken for each situation. The reasoning may take place by applying clustering mechanisms to identify the best, good, and bad outcomes for each situation, and to identify the ideal, normal, and corner-case situations. The cloud server 202 may send the preview to the edge node devices. The edge node devices may leverage the preview outcome, which may trigger AI execution plan updates (i.e., reinforcement learning).

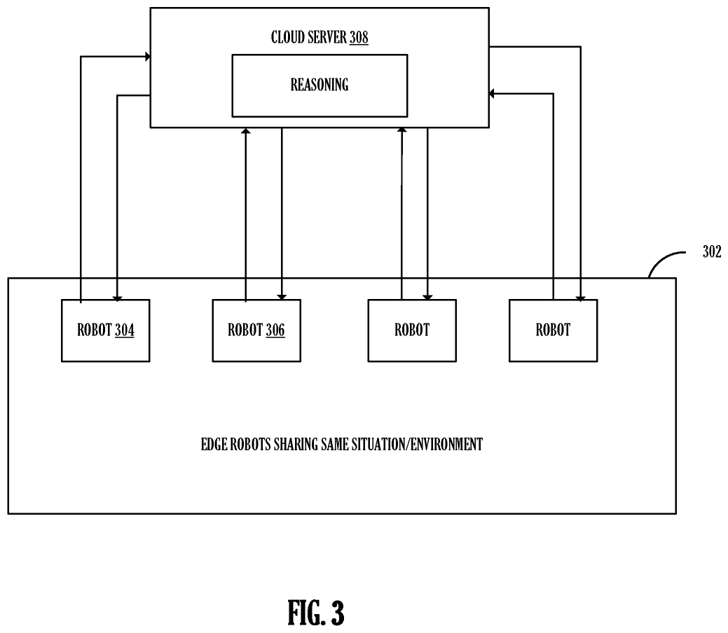

FIG. 3 is a block diagram of an example of an environment including a system for cumulative learning robot execution plan generation, according to an embodiment. In FIG. 3, an example of the Robots-in-Loop (RIL) process through a virtual environment 302 of the robots (e.g., a first robot 304 and a second robot 306) at the edge is shown.

The RIL process may include a cloud server 308 in communication with edge node devices connected to edge node robots. The robots may each share the same situation/environment (e.g., the virtual environment 302) to provide transfer learning. As the robots (e.g., the first robot 304 or the second robot 306) finish a task, the robots may share reports, also called an execution plan report, of the execution plan, ran by the robot and the outcome of the run. The cloud server 308 may request each of the edge node devices that share the same situation and have idle resources (or who are processing the same task for the same situation) to use an alternative execution plan. The edge robots within the RIL each respond to the request and provide an execution plan report of the execution plan used the outcome of execution.

In an example, the cloud server 308 may preview the different outcomes for each execution plan for a particular situation and may determine the right decision to be taken for the situation. The cloud server 308 may then transmit feedback to the edge node devices for the robots that ran the task with the original execution plans. If the transmitted feedback does not match the original execution plan, the edge node device may update the execution plan that the robot is running on the fly.

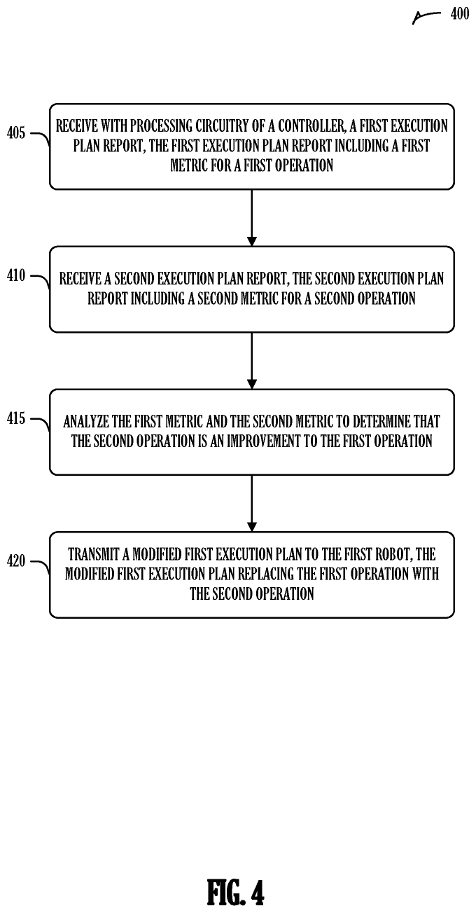

FIG. 4 illustrates a flow diagram of an example of a method 400. The method 400 may be for the cumulative learning robot execution plan generation. The method 400 may at least include the following.

At operation 405, a controller may receive with processing circuitry of the controller a first execution plan report. The first execution plan report including a first metric for a first operation of the first execution plan.

At operation 410, the controller may receive a second execution plan report. The second execution plan report may include a second metric for a second operation of the second execution plan.

At operation 415, the controller may compare the first metric to the second metric to determine that the second operation is an improvement to the first operation. In another example, the controller may determine that the first operation is an improvement to the second operation. In examples, the controller may compare the first and second metrics using the comparison techniques discussed above with reference to FIGS. 1-3. As a result of the comparison, the controller may generate a modified first execution plan that optimizes the first operation of the original first execution plan.

At operation 420, utilizing the analysis of the first and second metrics, the controller may generate a modified first execution plan that optimizes the first operation of the original first execution plan. In examples, the controller may replace the first operation with the second operation to generate the modified execution plan. the controller may transmit the modified first execution plan to a robot. The controller may transmit the modified first execution plan to a edge node device to live update the execution plan on the robot. As discussed above, the controller may update more than one operation of an execution plan to find an optimal execution plan for the given scenario.

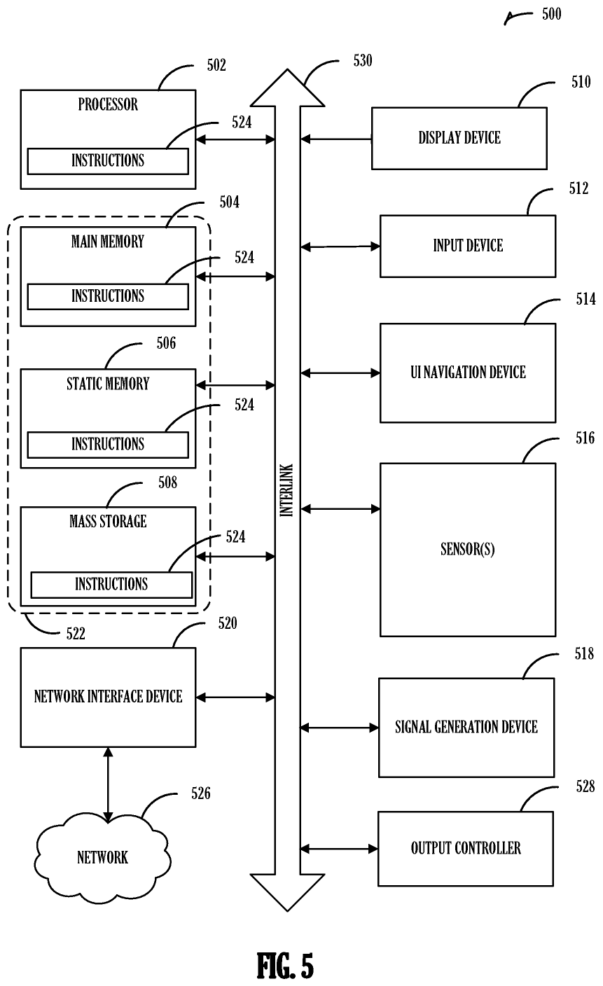

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is a device for cumulative learning robot execution plan generation, the device comprising: a memory including instructions; and processing circuitry that, when in operation, is configured by the instructions to: receive, with processing circuitry of a controller, a first execution plan report based on execution of a first execution plan by a first robot, the first execution plan report including a first metric for a first operation of the first execution plan; receive a second execution plan report based on execution of a second execution plan by a second robot, the second execution plan report including a second metric for a second operation of the second execution plan, the second operation corresponding to the first operation; analyze the first metric and the second metric to determine that the second operation is an improvement to the first operation; and transmit a modified first execution plan to the first robot, the modified first execution plan replacing the first operation with the second operation.

In Example 2, the subject matter of Example 1, wherein the first robot and the second robot are Autonomous Mobile Robots (AMRs) operating in similar environments.

In Example 3, the subject matter of any of Examples 1-2, wherein the first execution plan is a test plan, the test plan changing the first operation from an original of the first execution plan, and the comparison of the first metric and the second metric is indicative that the test plan is not an improvement over the second execution plan.

In Example 4, the subject matter of Example 3, wherein the controller invokes a cluster of edge nodes to analyze the test plan and the second execution plan to determine that the test plan is not an improvement over the second execution plan.

In Example 5, the subject matter of any of Examples 1-4, wherein the first robot and the second robot operate simultaneously.

In Example 6, the subject matter of any of Examples 1-5, wherein the second robot is simulated.

In Example 7, the subject matter of Example 6, wherein the first execution plan report includes a grouping of parameters of operation, the grouping of parameters defines boundaries of the operations of the first robot.

In Example 8, the subject matter of Example 7, wherein the instructions configure the processing circuitry to: generate a simulation environment based on the grouping of parameters.

In Example 9, the subject matter of any of Examples 7-8, wherein the instructions configure the processing circuitry to: execute the simulation; generate a first test execution plan and a second test execution plan, the first and second test execution plans each include one or more operations performed by a robot in the simulation; analyze results from the first and second test execution plans running in simulation to determine that the first test execution is an improvement to the second test execution plan; generate a new execution plan, the new execution plan including the first test execution plan; and transmit the new execution plan to the first robot.

In Example 10, the subject matter of Example 9, wherein one or more simulations are run in parallel.

In Example 11, the subject matter of any of Examples 6-10, wherein the first execution plan report includes a deviation, the deviation including a fault or variation from a predicted performance of the first robot during execution of the first execution plan.

In Example 12, the subject matter of Example 11, wherein the instructions configure the processing circuitry to: execute a simulation based on the deviation of the first execution plan report; generate multiple test execution plans, each of the test execution plans including a change to the first operation in the first execution plan; analyze metrics from the test execution plans running in the simulation to determine an updated test execution plan is an improvement over the other test execution plans; and transmit the updated test execution plan to the first robot.

Example 13 is a method for cumulative learning robot execution plan generation, the method comprising: receiving, by processing circuitry of a controller, a first execution plan report based on execution of a first execution plan by a first robot, the first execution plan report including a first metric for a first operation of the first execution plan; receiving a second execution plan report based on execution of a second execution plan by a second robot, the second execution plan report including a second metric for a second operation of the second execution plan, the second operation corresponding to the first operation; analyzing the first metric and the second metric to determine that the second operation is an improvement to the first operation; and transmitting a modified first execution plan to the first robot, the modified first execution plan replacing the first operation with the second operation.

In Example 14, the subject matter of Example 13, wherein the first robot and the second robot are Autonomous Mobile Robots (AMRs) operating in similar environments.

In Example 15, the subject matter of any of Examples 13-14, wherein the first execution plan is a test plan, the test plan changing the first operation from an original of the first execution plan, and the comparison of the first metric and the second metric is indicative that the test plan is not an improvement over the second execution plan.

In Example 16, the subject matter of Example 15, wherein the controller invokes a cluster of edge nodes to analyze the test plan and the second execution plan to determine that the test plan is not an improvement over the second execution plan.

In Example 17, the subject matter of any of Examples 13-16, wherein the first robot and the second robot operate simultaneously.

In Example 18, the subject matter of any of Examples 13-17, wherein the second robot is simulated.

In Example 19, the subject matter of Example 18, wherein the first execution plan report includes a grouping of parameters of operation, the grouping of parameters defines boundaries of the operations of the first robot.

In Example 20, the subject matter of Example 19, further comprising: generating a simulation environment based on the grouping of parameters.

In Example 21, the subject matter of any of Examples 19-20, further comprising: executing the simulation; generating a first test execution plan and a second test execution plan, the first and second test execution plans each include one or more operations performed by a robot in the simulation; analyzing results from the first and second test execution plans running in simulation to determine that the first test execution is an improvement to the second test execution plan; generating a new execution plan, the new execution plan including the first test execution plan; and transmitting the new execution plan to the first robot.

In Example 22, the subject matter of Example 21, wherein one or more simulations are run in parallel.

In Example 23, the subject matter of any of Examples 18-22, wherein the first execution plan report includes a deviation, the deviation including a fault or variation from a predicted performance of the first robot during execution of the first execution plan.

In Example 24, the subject matter of Example 23, further comprising: executing a simulation based on the deviation of the first execution plan report; generating multiple test execution plans, each of the test execution plans including a change to the first operation in the first execution plan; analyzing metrics from the test execution plans running in the simulation to determine an updated test execution plan is an improvement over the other test execution plans; and transmitting the updated test execution plan to the first robot.

Example 25 is at least one machine readable medium including instructions that, when executed by processing circuitry, cause the processing circuitry to perform any method of Examples 13-24.

Example 26 is a system comprising means to perform any method of Examples 13-24.

Example 27 is at least one machine readable medium including instructions for cumulative learning robot execution plan generation, the instructions, when executed by processing circuitry, cause the processing circuitry to perform operations comprising: receiving, by processing circuitry of a controller, a first execution plan report based on execution of a first execution plan by a first robot, the first execution plan report including a first metric for a first operation of the first execution plan; receiving a second execution plan report based on execution of a second execution plan by a second robot, the second execution plan report including a second metric for a second operation of the second execution plan, the second operation corresponding to the first operation; analyzing the first metric and the second metric to determine that the second operation is an improvement to the first operation; and transmitting a modified first execution plan to the first robot, the modified first execution plan replacing the first operation with the second operation.

In Example 28, the subject matter of Example 27, wherein the first robot and the second robot are Autonomous Mobile Robots (AMRs) operating in similar environments.

In Example 29, the subject matter of any of Examples 27-28, wherein the first execution plan is a test plan, the test plan changing the first operation from an original of the first execution plan, and the comparison of the first metric and the second metric is indicative that the test plan is not an improvement over the second execution plan.

In Example 30, the subject matter of Example 29, wherein the controller invokes a cluster of edge nodes to analyze the test plan and the second execution plan to determine that the test plan is not an improvement over the second execution plan.

In Example 31, the subject matter of any of Examples 27-30, wherein the first robot and the second robot operate simultaneously.

In Example 32, the subject matter of any of Examples 27-31, wherein the second robot is simulated.

In Example 33, the subject matter of Example 32, wherein the first execution plan report includes a grouping of parameters of operation, the grouping of parameters defines boundaries of the operations of the first robot.

In Example 34, the subject matter of Example 33, wherein the operations comprise: generating a simulation environment based on the grouping of parameters.

In Example 35, the subject matter of any of Examples 33-34, wherein the operations comprise: executing the simulation; generating a first test execution plan and a second test execution plan, the first and second test execution plans each include one or more operations performed by a robot in the simulation; analyzing results from the first and second test execution plans running in simulation to determine that the first test execution is an improvement to the second test execution plan; generating a new execution plan, the new execution plan including the first test execution plan; and transmitting the new execution plan to the first robot.

In Example 36, the subject matter of Example 35, wherein one or more simulations are run in parallel.

In Example 37, the subject matter of any of Examples 32-36, wherein the first execution plan report includes a deviation, the deviation including a fault or variation from a predicted performance of the first robot during execution of the first execution plan.

In Example 38, the subject matter of Example 37, wherein the operations comprise: executing a simulation based on the deviation of the first execution plan report; generating multiple test execution plans, each of the test execution plans including a change to the first operation in the first execution plan; analyzing metrics from the test execution plans running in the simulation to determine an updated test execution plan is an improvement over the other test execution plans; and transmitting the updated test execution plan to the first robot.

Example 39 is a system for cumulative learning robot execution plan generation, the system comprising: means for receiving, by processing circuitry of a controller, a first execution plan report based on execution of a first execution plan by a first robot, the first execution plan report including a first metric for a first operation of the first execution plan; means for receiving a second execution plan report based on execution of a second execution plan by a second robot, the second execution plan report including a second metric for a second operation of the second execution plan, the second operation corresponding to the first operation; means for analyzing the first metric to the second metric to determine that the second operation is an improvement to the first operation; and means for transmitting a modified first execution plan to the first robot, the modified first execution plan replacing the first operation with the second operation.

In Example 40, the subject matter of Example 39, wherein the first robot and the second robot are Autonomous Mobile Robots (AMRs) operating in similar environments.

In Example 41, the subject matter of any of Examples 39-40, wherein the first execution plan is a test plan, the test plan changing the first operation from an original of the first execution plan, and the comparison of the first metric and the second metric is indicative that the test plan is not an improvement over the second execution plan.

In Example 42, the subject matter of Example 41, wherein the controller invokes a cluster of edge nodes to analyze the test plan and the second execution plan to determine that the test plan is not an improvement over the second execution plan.

In Example 43, the subject matter of any of Examples 39-42, wherein the first robot and the second robot operate simultaneously.

In Example 44, the subject matter of any of Examples 39-43, wherein the second robot is simulated.

In Example 45, the subject matter of Example 44, wherein the first execution plan report includes a grouping of parameters of operation, the grouping of parameters defines boundaries of the operations of the first robot.

In Example 46, the subject matter of Example 45, comprising: means for generating a simulation environment based on the grouping of parameters.

In Example 47, the subject matter of any of Examples 45-46, comprising: means for executing the simulation; means for generating a first test execution plan and a second test execution plan, the first and second test execution plans each include one or more operations performed by a robot in the simulation; means for analyzing results from the first and second test execution plans running in simulation to determine that the first test execution is an improvement to the second test execution plan; means for generating a new execution plan, the new execution plan including the first test execution plan; and means for transmitting the new execution plan to the first robot.

In Example 48, the subject matter of Example 47, wherein one or more simulations are run in parallel.

In Example 49, the subject matter of any of Examples 44-48, wherein the first execution plan report includes a deviation, the deviation including a fault or variation from a predicted performance of the first robot during execution of the first execution plan.

In Example 50, the subject matter of Example 49, comprising: means for executing a simulation based on the deviation of the first execution plan report; means for generating multiple test execution plans, each of the test execution plans including a change to the first operation in the first execution plan; means for analyzing metrics from the test execution plans running in the simulation to determine an updated test execution plan is an improvement over the other test execution plans; and means for transmitting the updated test execution plan to the first robot.

Example 51 is at least one machine-readable medium including instructions that, when executed by processing circuitry, cause the processing circuitry to perform operations to implement of any of Examples 1-50.

Example 52 is an apparatus comprising means to implement of any of Examples 1-50.

Example 53 is a system to implement of any of Examples 1-50.

Example 54 is a method to implement of any of Examples 1-50.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for cumulative learning robot execution plan generation, the device comprising:
a memory including instructions; and
processing circuitry that, when in operation, is configured by the instructions to:
receive, with processing circuitry of a controller, a first execution plan report based on execution of a first execution plan by a first robot, the first execution plan report including a first metric for a first operation of the first execution plan;
receive a second execution plan report based on execution of a second execution plan by a second robot, the second execution plan report including a second metric for a second operation of the second execution plan, the second operation corresponding to the first operation;
analyze the first metric and the second metric to determine that the second operation is an improvement to the first operation; and
transmit a modified first execution plan to the first robot, the modified first execution plan replacing the first operation with the second operation.

2. The device of claim 1, wherein the first execution plan is a test plan, the test plan changing the first operation from an original of the first execution plan, and the comparison of the first metric and the second metric is indicative that the test plan is not an improvement over the second execution plan.

3. The device of claim 2, wherein the controller invokes a cluster of edge nodes to analyze the test plan and the second execution plan to determine that the test plan is not an improvement over the second execution plan.

4. The device of claim 1, wherein the second robot is simulated.

5. The device of claim 4, wherein the first execution plan report includes a grouping of parameters of operation, the grouping of parameters defines boundaries of the operations of the first robot.

6. The device of claim 5, wherein the instructions configure the processing circuitry to:
generate a simulation environment based on the grouping of parameters.

7. The device of claim 6, wherein the instructions configure the processing circuitry to:
execute the simulation;
generate a first test execution plan and a second test execution plan, the first and second test execution plans each include one or more operations performed by a robot in the simulation;
analyze results from the first and second test execution plans running in simulation to determine that the first test execution is an improvement to the second test execution plan;
generate a new execution plan, the new execution plan including the first test execution plan; and
transmit the new execution plan to the first robot.

8. The device of claim 4, wherein the first execution plan report includes a deviation, the deviation including a fault or variation from a predicted performance of the first robot during execution of the first execution plan.

9. The device of claim 8, wherein the instructions configure the processing circuitry to:
execute a simulation based on the deviation of the first execution plan report;
generate multiple test execution plans, each of the test execution plans including a change to the first operation in the first execution plan;
analyze metrics from the test execution plans running in the simulation to determine an updated test execution plan is an improvement over the other test execution plans; and
transmit the updated test execution plan to the first robot.

10. At least one non-transient machine readable medium including instructions for cumulative learning robot execution plan generation, the instructions, when executed by processing circuitry, cause the processing circuitry to perform operations comprising:
receiving, by processing circuitry of a controller, a first execution plan report based on execution of a first execution plan by a first robot, the first execution plan report including a first metric for a first operation of the first execution plan;
receiving a second execution plan report based on execution of a second execution plan by a second robot, the second execution plan report including a second metric for a second operation of the second execution plan, the second operation corresponding to the first operation;
analyzing the first metric and the second metric to determine that the second operation is an improvement to the first operation; and
transmitting a modified first execution plan to the first robot, the modified first execution plan replacing the first operation with the second operation.

11. The non-transient machine readable medium of claim 10, wherein the first execution plan is a test plan, the test plan changing the first operation from an original of the first execution plan, and the comparison of the first metric and the second metric is indicative that the test plan is not an improvement over the second execution plan.

12. The non-transient machine readable medium of claim 11, wherein the controller invokes a cluster of edge nodes to analyze the test plan and the second execution plan to determine that the test plan is not an improvement over the second execution plan.

13. The non-transient machine readable medium of claim 10, wherein the second robot is simulated.

14. The non-transient machine readable medium of claim 13, wherein the first execution plan report includes a grouping of parameters of operation, the grouping of parameters defines boundaries of the operations of the first robot.

15. The non-transient machine readable medium of claim 14, wherein the operations comprise:
generating a simulation environment based on the grouping of parameters.

16. The non-transient machine readable medium of claim 15, wherein the operations comprise:
executing the simulation;
generating a first test execution plan and a second test execution plan, the first and second test execution plans each include one or more operations performed by a robot in the simulation;
analyzing results from the first and second test execution plans running in simulation to determine that the first test execution is an improvement to the second test execution plan;
generating a new execution plan, the new execution plan including the first test execution plan; and
transmitting the new execution plan to the first robot.

17. The non-transient machine readable medium of claim 13, wherein the first execution plan report includes a deviation, the deviation including a fault or variation from a predicted performance of the first robot during execution of the first execution plan.

18. The non-transient machine readable medium of claim 17, wherein the operations comprise:
executing a simulation based on the deviation of the first execution plan report;
generating multiple test execution plans, each of the test execution plans including a change to the first operation in the first execution plan;
analyzing metrics from the test execution plans running in the simulation to determine an updated test execution plan is an improvement over the other test execution plans; and
transmitting the updated test execution plan to the first robot.

19. A system for cumulative learning robot execution plan generation, the system comprising:
means for receiving, by processing circuitry of a controller, a first execution plan report based on execution of a first execution plan by a first robot, the first execution plan report including a first metric for a first operation of the first execution plan;
means for receiving a second execution plan report based on execution of a second execution plan by a second robot, the second execution plan report including a second metric for a second operation of the second execution plan, the second operation corresponding to the first operation;
means for analyzing the first metric to the second metric to determine that the second operation is an improvement to the first operation; and
means for transmitting a modified first execution plan to the first robot, the modified first execution plan replacing the first operation with the second operation.

20. The system of claim 19, wherein the first execution plan is a test plan, the test plan changing the first operation from an original of the first execution plan, and the comparison of the first metric and the second metric is indicative that the test plan is not an improvement over the second execution plan.

21. The system of claim 20, wherein the controller invokes a cluster of edge nodes to analyze the test plan and the second execution plan to determine that the test plan is not an improvement over the second execution plan.

22. The system of claim 19, wherein the second robot is simulated.

23. The system of claim 22, wherein the first execution plan report includes a grouping of parameters of operation, the grouping of parameters defines boundaries of the operations of the first robot.

24. The system of claim 23, comprising:
means for generating a simulation environment based on the grouping of parameters.

25. The system of claim 24, comprising:
means for executing the simulation;
means for generating a first test execution plan and a second test execution plan, the first and second test execution plans each include one or more operations performed by a robot in the simulation;
means for analyzing results from the first and second test execution plans running in simulation to determine that the first test execution is an improvement to the second test execution plan;
means for generating a new execution plan, the new execution plan including the first test execution plan; and
means for transmitting the new execution plan to the first robot.
